(19) United States
(12) Patent Application Publication
(10) Pub. No.: US 2025/0380248 A1
(43) Pub. Date: Dec. 11, 2025

(54) DIVIDED SPECTRUM TRANSMISSIONS IN WIRELESS COMMUNICATIONS

(71) Applicant: QUALCOMM Incorporated, San Diego, CA (US)

(72) Inventors: Idan Michael HORN, Hod Hasharon (IL); Yehonatan DALLAL, Kfar Saba (IL); Assaf TOUBOUL, Netanya (IL); Amit BAR-OR TILLINGER, Tel-Aviv (IL)

(21) Appl. No.: 18/739,872

(22) Filed: Jun. 11, 2024

(51) Int. Cl. H04W 72/0453; H04B 7/06; H04W 16/28; H04W 72/231; H04W 72/51

(52) U.S. Cl. CPC H04W 72/0453; H04B 7/0626; H04W 16/28; H04W 72/231; H04W 72/51

(57) ABSTRACT

Methods, systems, and devices for wireless communications are described. A user equipment (UE) may transmit signaling that may indicate a capability of the UE to support a divided spectrum for communications between the UE and a network entity. The divided spectrum may include division of a channel bandwidth into multiple of subbands according to a quantity of antennas at the UE. The UE may receive control signaling that may includes a division pattern that is based on the capability of the UE, where the division pattern may indicate the division of the channel bandwidth into the multiple subbands and may indicate a mapping between the antennas of the UE and the multiple subbands. Accordingly, the UE may communicate with the network entity via the antennas across the multiple subbands according to the division pattern.

### FIELD OF TECHNOLOGY

The following relates to wireless communications, including divided spectrum transmissions in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a user equipment (UE) is described. The method may include one or more memories storing processor-executable code, one or more processors coupling with the one or more memories and individually or collectively operable to execute the code to cause the UE to, transmitting signaling that indicates a capability of the UE to support a divided spectrum for communications between the UE and a network entity, where the dividing spectrum includes division of a channel bandwidth into a set of multiple subbands in accordance with a set of multiple antennas at the UE, receiving control signaling that includes a division pattern that is based on the capability of the UE, where the division pattern indicating the division of the channel bandwidth into the set of multiple subbands and indicates a mapping between the set of multiple antennas and the set of multiple subbands, and communicating, with the network entity, via the set of multiple antennas across the set of multiple subbands according to the division pattern.

A UE is described. The UE may include one or more memories storing processor executable code, and one or more processors coupled with the one or more memories. The one or more processors may individually or collectively be operable to execute the code to cause the UE to one or more memories storing processor-executable code, one or more processors coupled with the one or more memories and individually or collectively operable to execute the code to cause the UE to, transmit signaling that indicates a capability of the UE to support a divided spectrum for communications between the UE and a network entity, where the divided spectrum includes division of a channel bandwidth into a set of multiple subbands in accordance with a set of multiple antennas at the UE, receive control signaling that includes a division pattern that is based on the capability of the UE, where the division pattern indicates the division of the channel bandwidth into the set of multiple subbands and indicates a mapping between the set of multiple antennas and the set of multiple subbands, and communicate, with the network entity, via the set of multiple antennas across the set of multiple subbands according to the division pattern.

Another UE is described. The UE may include means for one or more memories storing processor-executable code, means for one or more processors coupling with the one or more memories and individually or collectively operable to execute the code to cause the UE to, means for transmitting signaling that indicates a capability of the UE to support a divided spectrum for communications between the UE and a network entity, means for where the dividing spectrum includes division of a channel bandwidth into a set of multiple subbands in accordance with a set of multiple antennas at the UE, means for receiving control signaling that includes a division pattern that is based on the capability of the UE, means for where the division pattern indicating the division of the channel bandwidth into the set of multiple subbands and indicates a mapping between the set of multiple antennas and the set of multiple subbands, and means for communicating, with the network entity, via the set of multiple antennas across the set of multiple subbands according to the division pattern.

A non-transitory computer-readable medium storing code is described. The code may include instructions executable by one or more processors to one or more memories storing processor-executable code, one or more processors coupled with the one or more memories and individually or collectively operable to execute the code to cause the UE to, transmit signaling that indicates a capability of the UE to support a divided spectrum for communications between the UE and a network entity, where the divided spectrum includes division of a channel bandwidth into a set of multiple subbands in accordance with a set of multiple antennas at the UE, receive control signaling that includes a division pattern that is based on the capability of the UE, where the division pattern indicates the division of the channel bandwidth into the set of multiple subbands and indicates a mapping between the set of multiple antennas and the set of multiple subbands, and communicate, with the network entity, via the set of multiple antennas across the set of multiple subbands according to the division pattern.

In some examples of the method, UEs, and non-transitory computer-readable medium described herein, each antenna of the set of multiple antennas may be mapped to a respective subband of the set of multiple subbands.

In some examples of the method, UEs, and non-transitory computer-readable medium described herein, a first subset of the set of multiple antennas may be mapped to a first subband of the set of multiple subbands and a second subset of the set of multiple antennas may be mapped to a second subband of the set of multiple subbands in accordance with the mapping.

Some examples of the method, UEs, and non-transitory computer-readable medium described herein may further include operations, features, means, or instructions for receiving second control signaling that includes a second division pattern that adds one or more antennas of the set of multiple antennas to the first subset of the set of multiple antennas, adds one or more antennas of the set of multiple antennas to the second subset of the set of multiple antennas, or both and where communicating with the network entity may be based on the second control signaling.

Some examples of the method, UEs, and non-transitory computer-readable medium described herein may further include operations, features, means, or instructions for receiving second control signaling that includes a second division pattern that removes one or more antennas of the set of multiple antennas from the first subset of the set of multiple antennas, removes one or more antennas of the set of multiple antennas from the second subset of the set of multiple antennas, or both and where communicating with the network entity may be based on the second control signaling.

Some examples of the method, UEs, and non-transitory computer-readable medium described herein may further include operations, features, means, or instructions for receiving second control signaling that indicates for the UE to increase an output power of the set of multiple antennas across the set of multiple subbands based on an equivalent isotropic radiated power (EIRP) of the set of multiple antennas failing to satisfy a threshold and where communicating with the network entity may be based on increasing the output power of the set of multiple antennas.

In some examples of the method, UEs, and non-transitory computer-readable medium described herein, a physical resource group size associated the communications between the UE and the network entity may be based on a quantity of the set of multiple subbands, and communicating with the network entity may be in accordance with the physical resource group size.

Some examples of the method, UEs, and non-transitory computer-readable medium described herein may further include operations, features, means, or instructions for performing a beam management procedure using one or more channel state information reference signals, where the one or more channel state information reference signals may be based on one of a layout of the set of multiple antennas at the UE or the division pattern, and where communicating with the network entity may be based on performance of the beam management procedure.

In some examples of the method, UEs, and non-transitory computer-readable medium described herein, the signaling further indicates a quantity of the set of multiple antennas at the UE, a first distance between each antenna in the set of multiple antennas in a first direction, a second distance between each antenna of the set of multiple antennas in a second direction, or a combination thereof, and the division pattern may be based on the quantity of the set of multiple antennas at the UE, the first distance, the second distance, or a combination thereof.

In some examples of the method, UEs, and non-transitory computer-readable medium described herein, the signaling further indicates a threshold quantity of the set of multiple subbands supported at the UE, and the division pattern may be based on the threshold quantity of the set of multiple subbands.

In some examples of the method, UEs, and non-transitory computer-readable medium described herein, the signaling further indicates a threshold output power of a power amplifier of the UE, and the division pattern may be based on the threshold output power of the power amplifier of the UE.

In some examples of the method, UEs, and non-transitory computer-readable medium described herein, the control signaling includes one of radio resource control (RRC) signaling, downlink control information, a medium access control-control element (MAC-CE), or a combination thereof.

In some examples of the method, UEs, and non-transitory computer-readable medium described herein, the network entity includes a satellite or a gNB.

A method for wireless communications by a UE is described. The method may include transmitting signaling that indicates a capability of the UE to support a divided spectrum for communications between the UE and a network entity, where the divided spectrum includes division of a channel bandwidth into a set of multiple subbands in accordance with a set of multiple antennas at the UE, receiving control signaling that includes a division pattern that is based on the capability of the UE, where the division pattern indicates the division of the channel bandwidth into the set of multiple subbands and indicates a mapping between the set of multiple antennas and the set of multiple subbands, and communicating, with the network entity, via the set of multiple antennas across the set of multiple subbands according to the division pattern.

A UE for wireless communications is described. The UE may include one or more memories storing processor executable code, and one or more processors coupled with the one or more memories. The one or more processors may individually or collectively be operable to execute the code to cause the UE to transmit signaling that indicates a capability of the UE to support a divided spectrum for communications between the UE and a network entity, where the divided spectrum includes division of a channel bandwidth into a set of multiple subbands in accordance with a set of multiple antennas at the UE, receive control signaling that includes a division pattern that is based on the capability of the UE, where the division pattern indicates the division of the channel bandwidth into the set of multiple subbands and indicates a mapping between the set of multiple antennas and the set of multiple subbands, and communicate, with the network entity, via the set of multiple antennas across the set of multiple subbands according to the division pattern.

Another UE for wireless communications is described. The UE may include means for transmitting signaling that indicates a capability of the UE to support a divided spectrum for communications between the UE and a network entity, where the divided spectrum includes division of a channel bandwidth into a set of multiple subbands in accordance with a set of multiple antennas at the UE, means for receiving control signaling that includes a division pattern that is based on the capability of the UE, where the division pattern indicates the division of the channel bandwidth into the set of multiple subbands and indicates a mapping between the set of multiple antennas and the set of multiple subbands, and means for communicating, with the network entity, via the set of multiple antennas across the set of multiple subbands according to the division pattern.

A non-transitory computer-readable medium storing code for wireless communications is described. The code may include instructions executable by one or more processors to transmit signaling that indicates a capability of the UE to support a divided spectrum for communications between the UE and a network entity, where the divided spectrum includes division of a channel bandwidth into a set of multiple subbands in accordance with a set of multiple antennas at the UE, receive control signaling that includes a division pattern that is based on the capability of the UE, where the division pattern indicates the division of the channel bandwidth into the set of multiple subbands and indicates a mapping between the set of multiple antennas and the set of multiple subbands, and communicate, with the network entity, via the set of multiple antennas across the set of multiple subbands according to the division pattern.

In some examples of the method, UEs, and non-transitory computer-readable medium described herein, each antenna of the set of multiple antennas may be mapped to a respective subband of the set of multiple subbands.

In some examples of the method, UEs, and non-transitory computer-readable medium described herein, a first subset of the set of multiple antennas may be mapped to a first subband of the set of multiple subbands and a second subset of the set of multiple antennas may be mapped to a second subband of the set of multiple subbands in accordance with the mapping.

Some examples of the method, UEs, and non-transitory computer-readable medium described herein may further include operations, features, means, or instructions for receiving second control signaling that includes a second division pattern that adds one or more antennas of the set of multiple antennas to the first subset of the set of multiple antennas, adds one or more antennas of the set of multiple antennas to the second subset of the set of multiple antennas, or both and where communicating with the network entity may be based on the second control signaling.

Some examples of the method, UEs, and non-transitory computer-readable medium described herein may further include operations, features, means, or instructions for receiving second control signaling that includes a second division pattern that removes one or more antennas of the set of multiple antennas from the first subset of the set of multiple antennas, removes one or more antennas of the set of multiple antennas from the second subset of the set of multiple antennas, or both and where communicating with the network entity may be based on the second control signaling.

Some examples of the method, UEs, and non-transitory computer-readable medium described herein may further include operations, features, means, or instructions for performing a beam management procedure using one or more channel state information reference signals, where the one or more channel state information reference signals may be based on one of a layout of the set of multiple antennas at the UE or the division pattern and where communicating with the network entity may be based on performance of the beam management procedure.

A method for wireless communications at a UE by an apparatus is described. The method may include transmitting signaling that indicates a capability of the UE to support a divided spectrum for communications between the UE and a network entity, where the divided spectrum includes division of a channel bandwidth into a set of multiple subbands in accordance with a set of multiple antennas at the UE, receiving control signaling that includes a division pattern that is based on the capability of the UE, where the division pattern indicates the division of the channel bandwidth into the set of multiple subbands and indicates a mapping between the set of multiple antennas and the set of multiple subbands, and communicating, with the network entity, via the set of multiple antennas across the set of multiple subbands according to the division pattern.

An apparatus for wireless communications at a UE is described. The apparatus may include one or more memories storing processor executable code, and one or more processors coupled with the one or more memories. The one or more processors may individually or collectively be operable to execute the code to cause the apparatus to transmit signaling that indicates a capability of the UE to support a divided spectrum for communications between the UE and a network entity, where the divided spectrum includes division of a channel bandwidth into a set of multiple subbands in accordance with a set of multiple antennas at the UE, receive control signaling that includes a division pattern that is based on the capability of the UE, where the division pattern indicates the division of the channel bandwidth into the set of multiple subbands and indicates a mapping between the set of multiple antennas and the set of multiple subbands, and communicate, with the network entity, via the set of multiple antennas across the set of multiple subbands according to the division pattern.

Another apparatus for wireless communications at a UE is described. The apparatus may include means for transmitting signaling that indicates a capability of the UE to support a divided spectrum for communications between the UE and a network entity, where the divided spectrum includes division of a channel bandwidth into a set of multiple subbands in accordance with a set of multiple antennas at the UE, means for receiving control signaling that includes a division pattern that is based on the capability of the UE, where the division pattern indicates the division of the channel bandwidth into the set of multiple subbands and indicates a mapping between the set of multiple antennas and the set of multiple subbands, and means for communicating, with the network entity, via the set of multiple antennas across the set of multiple subbands according to the division pattern.

A non-transitory computer-readable medium storing code for wireless communications at a UE is described. The code may include instructions executable by one or more processors to transmit signaling that indicates a capability of the UE to support a divided spectrum for communications between the UE and a network entity, where the divided spectrum includes division of a channel bandwidth into a set of multiple subbands in accordance with a set of multiple antennas at the UE, receive control signaling that includes a division pattern that is based on the capability of the UE, where the division pattern indicates the division of the channel bandwidth into the set of multiple subbands and indicates a mapping between the set of multiple antennas and the set of multiple subbands, and communicate, with the network entity, via the set of multiple antennas across the set of multiple subbands according to the division pattern.

### BRIEF DESCRIPTION OF THE DRAWINGS

FIG. 1 shows an example of a wireless communications system that supports divided spectrum transmissions in wireless communications in accordance with one or more aspects of the present disclosure.

FIG. 2 shows an example of a wireless communications system that supports divided spectrum transmissions in wireless communications in accordance with one or more aspects of the present disclosure.

FIG. 3 shows an example of an antenna structure that supports divided spectrum transmissions in wireless communications in accordance with one or more aspects of the present disclosure.

FIG. 4 shows an example of an antenna structure that supports divided spectrum transmissions in wireless communications in accordance with one or more aspects of the present disclosure.

FIG. 5 shows an example of a process flow that supports divided spectrum transmissions in wireless communications in accordance with one or more aspects of the present disclosure.

FIGS. 6 and 7 show block diagrams of devices that support divided spectrum transmissions in wireless communications in accordance with one or more aspects of the present disclosure.

FIG. 8 shows a block diagram of a communications manager that supports divided spectrum transmissions in wireless communications in accordance with one or more aspects of the present disclosure.

FIG. 9 shows a diagram of a system including a device that supports divided spectrum transmissions in wireless communications in accordance with one or more aspects of the present disclosure.

FIGS. 10 and 11 show flowcharts illustrating methods that support divided spectrum transmissions in wireless communications in accordance with one or more aspects of the present disclosure.

### DETAILED DESCRIPTION

Some wireless communications systems may support communication between a user equipment (UE) and a network entity (e.g., a next generation node B (gNB) or a satellite). For example, the UE may transmit radio frequency signals to the network entity using antenna arrays. In such examples, communications via such antenna arrays may be performed according to a threshold (e.g., a maximum permissible exposure (MPE) threshold), which may limit the strength of radio frequency emissions emitted during such transmissions. For example, a transmit power (e.g., equivalent isotropic radiated power (EIRP)) across the antenna arrays may be limited due to the MPE threshold, where the limited transmit power across the antenna arrays may result in a reduced coverage area of the UE, reduced quality of communications between the UE and the network entity, or a combination thereof. Thus, techniques to increase the transmit power for communications between the UE and the network entity may be desired, while also conforming to the MPE threshold.

As described herein, the UE may implement an antenna structure and support communications over a divided spectrum, which may enable the UE to communicate with the network entity using increased transmission power, while also satisfying the MPE threshold during the communications. For example, the UE may implement an antenna structure that spaces apart each antenna, such that each antenna may transmitted at an increased power level, while also conforming to the MPE threshold. Accordingly, the UE may transmit signaling that indicates a capability of the UE to support the divided spectrum for communications between the UE and the network entity. The divided spectrum may include a division of a channel bandwidth into multiple subbands according to the antenna structure at the UE.

In response to transmitting the signaling, the UE may receive control signaling from the network entity that includes a division pattern that is based on the indicated capability of the UE. The division pattern may indicate the division of the channel bandwidth into the multiple subbands and may also indicate a mapping between the antennas at the UE and the multiple subbands. Based on receiving the control signaling, the UE may communicate with the network entity via the antennas across the subbands according to the division pattern.

By implementing the described antenna array structure, the UE may increase the EIRP of the antennas, while also conforming to the MPE threshold, thereby improving communications between the UE and the network entity and increasing the coverage area at the UE. Additionally, by implementing the divided spectrum across the antenna structure, the UE may avoid generation of grating lobes, thereby decreasing interference during communications, and increasing the quality of communications between the UE and the network entity. By enabling the network entity to determine and signal the division pattern, the network entity may determine whether one or more antennas may be mapped to a same subband, which may further increase the directivity gain of communications, leading to improved signaling.

Aspects of the disclosure are initially described in the context of wireless communications systems. Aspects of the disclosure are then described with reference to wireless communications systems, divided spectrums, and process flows. Aspects of the disclosure are further illustrated by and described with reference to apparatus diagrams, system diagrams, and flowcharts that relate to divided spectrum transmissions in wireless communications.

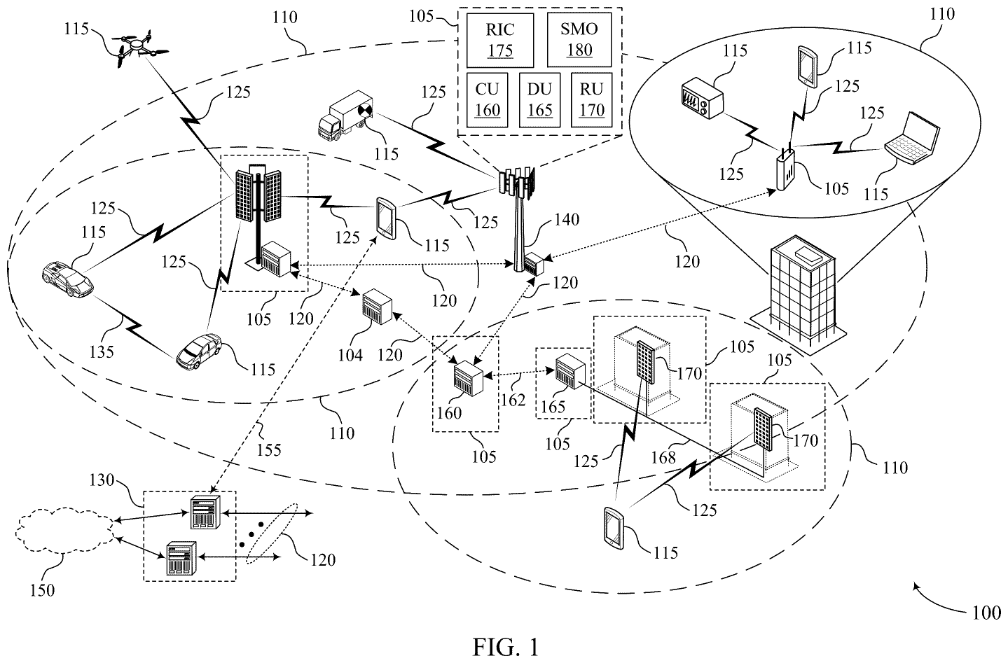

FIG. 1 shows an example of a wireless communications system 100 that supports divided spectrum transmissions in wireless communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antennas of an antenna array such that some signals propagating along particular orientations with respect to an antenna array experience constructive interference while others experience destructive interference. The adjustment of signals communicated via the antennas may include a transmitting device or a receiving device applying amplitude offsets, phase offsets, or both to signals carried via the antennas associated with the device. The adjustments associated with each of the antennas may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antennas of an antenna array, or by processing received signals according to different receive beamforming weight sets applied to signals received at multiple antennas of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

As described herein, the UE 115 may implement an antenna structure and support communications over a divided spectrum, which may enable the UE 115 to communicate with the network entity 105 using increased transmission power, while also satisfying the MPE threshold during the communications. For example, the UE 115 may implement an antenna structure that spaces apart each antenna, such that each antenna may transmitted at an increased power level, while also conforming to the MPE threshold. Accordingly, the UE 115 may transmit signaling that indicates a capability of the UE 115 to support the divided spectrum for communications between the UE 115 and the network entity 105. The divided spectrum may include a division of a channel bandwidth into multiple subbands according to the antenna structure at the UE 115.

In response to transmitting the signaling, the UE 115 may receive control signaling from the network entity 105 that includes a division pattern that is based on the indicated capability of the UE 115. The division pattern may indicate the division of the channel bandwidth into the multiple subbands and may also indicate a mapping between the antennas at the UE 115 and the multiple subbands. Based on receiving the control signaling, the UE 115 may communicate with the network entity 105 via the antennas across the subbands according to the division pattern.

By implementing the described antenna array structure, the UE 115 may increase the EIRP of the antennas, while also conforming to the MPE threshold, thereby improving communications between the UE 115 and the network entity 105 and increasing the coverage area at the UE 115. Additionally, by implementing the divided spectrum across the antenna structure, the UE 115 may avoid generation of grating lobes, thereby decreasing interference during communications and increasing the quality of communications between the UE 115 and the network entity 105. By enabling the network entity 105 to determine and signal the division pattern, the network entity 105 may determine whether one or more antennas may be mapped to a same subband, which may further increase the directivity gain of communications, leading to improved signaling.

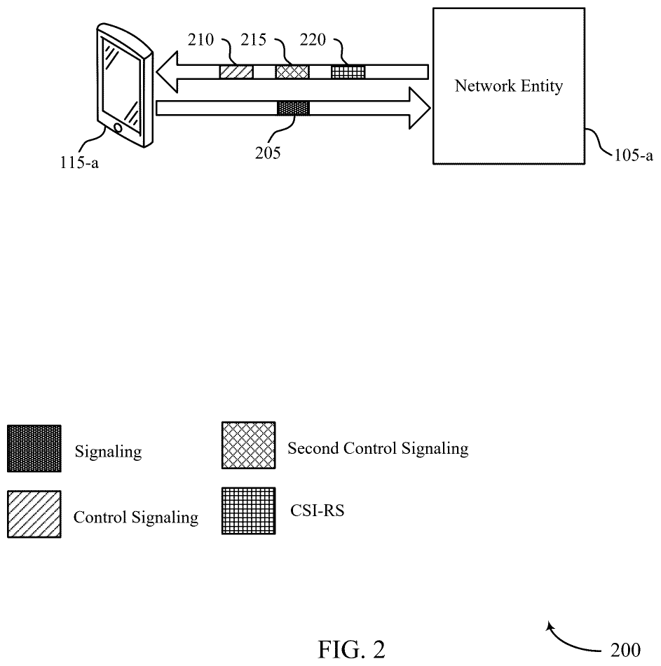

FIG. 2 shows an example of a wireless communications system 200 that supports divided spectrum transmissions in wireless communications in accordance with one or more aspects of the present disclosure. The wireless communications system 200 may include a network entity 105-a and a UE 115-a, which may be examples of a network entity 105 and a UE 115 as described with reference to FIG. 1. The UE 115-a and the network entity 105-a may support improved signaling techniques for divided spectrum transmission between the UE 115-a and the network entity 105-a.

In some wireless communications systems, the UE 115-a and the network entity 105-a may utilize uplink channels (e.g., millimeter wave communications) to communicate. However, communication via such uplink channels may limit the coverage of a cell due to a MPE threshold value of 10 W/m² or 1 mW/cm². Such MPE thresholds may have a relaxation of measuring the average power of a rectangular area, where the rectangular area may be an averaging area of 4 cm² around a single antenna. For example, the MPE threshold value may limit the average output power of antennas that reside within a 4 cm² area on the UE 115-a. As a result, the output power (e.g., EIRP) of a single antenna within the coverage area may be a threshold value of 4 mW or 6 dBm, which may limit communications with the network entity 105-a.

As an illustrative example, the UE 115-a may include an antenna array of 8 antennas arranged in a 4×2 within a 4 cm² area on the UE 115-a. Accordingly, the EIRP of the 8 antennas may not increase compared to that of a single antenna (e.g., the output power across the 8 antennas is the same as the output power of a single antenna due to the MPE threshold value). As another illustrative example, the UE 115 may include an antenna array that is 8 antennas long, where 4 antennas of the array are within a first 4 cm² area and the other 4 antennas are within a second 4 cm² area. In such examples, the EIRP may be 8 mW or 0 dBm, or double that of a single antenna (e.g., due to 8 antenna array residing across two 4 cm² areas). In such examples, the threshold EIRP that may be measured while maintaining the MPE threshold may be found using the following equation:

$${EIRP}_{@ M P E} = x d B + y d B i + z d B m$$

where xdB is related to a power gain, ydBi is related to a power of a patch within the spectrum, and zdBm is related to a PA.

In such examples, however, due to the MPE threshold, the UE 115-a may be unable to increase the power of the antennas beyond that restricted by the MPE threshold, thereby reducing communication quality, reducing the coverage area of the UE 115-a, or both.

According to the techniques described herein, the UE 115-a may experience improved coverage and increased EIRP by using a non-MPE limited antenna. Additionally, the UE 115-a may support a divided spectrum, in addition to the non-MPE limited antenna array structure, to increase the average EIRP of transmissions, thereby improving cell coverage.

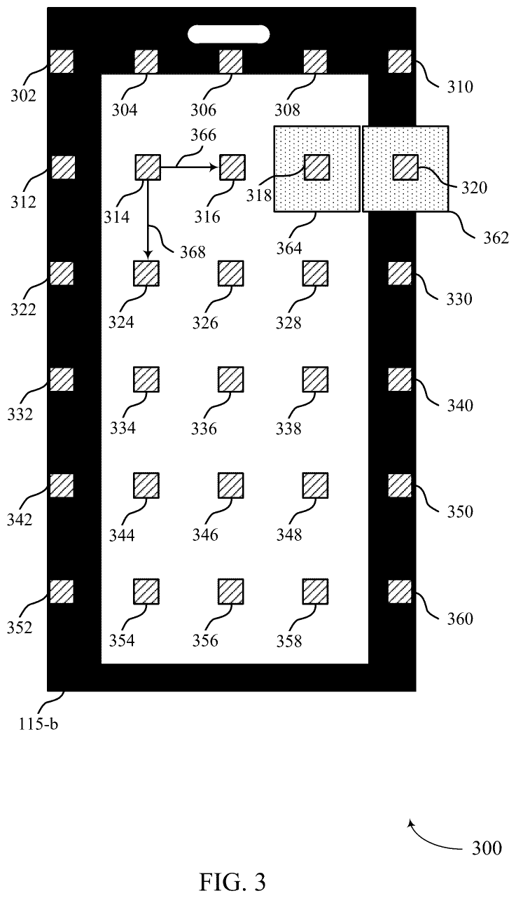

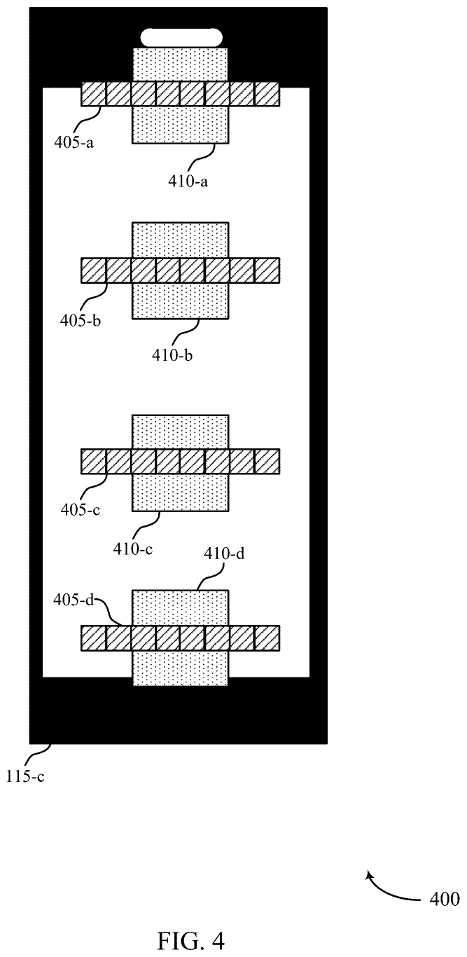

For example, the non-MPE limited antenna array structure may space the antennas within the MPE squared limitation, such that each antenna may be viewed as a single antenna from the perspective of the MPE, which may enable the UE 115-a to increase the power amplifier output to each antenna, thereby improving coverage. That is, in the non-MPE limited antenna array structure, each antenna may reside within a single 4 cm² area, such that cumulative transmission power across the entire antenna structure may be increased. Techniques for such antenna structures may be further described herein with reference to FIGS. 3 and 4.

In some examples, the UE 115-a may communicate using the aforementioned antenna structure, where the UE 115-a transmits a signal via each antenna on a same frequency. However, due to the spacing of the antennas and while transmitting on the same frequency, the UE 115—may experience grating lobes. Such grating lobes may spread into multiple unwanted directions and, thus, cause interference among the other transmissions in the cell area.

As such, to limit interference due to grating lobes, the wireless communications system 200 may support the divided spectrum in which the bandwidth over which the UE 115-a is transmitting may be divided into multiple subbands according to the quantity of antennas included in the UE 115-a. In such examples, each antenna may transmit over a different subband included in the spectrum and thereby eliminate grating lobes. For example, the UE 115-a may be transmitting over a 10 MHz bandwidth and the UE 115-a may divide the 10 MHz bandwidth into a quantity of 1 MHz subbands according to the quantity of antennas. The UE 115-a may then transmit on the 1 MHz subbands via each antenna rather than transmitting on the 10 MHz bandwidth via the quantity of antennas.

To support such divided spectrum transmissions, the UE 115-a and the network entity 105-a may implement various signaling procedures. For example, the UE 115-a may transmit signaling 205 (e.g., uplink control information (UCI) to the network entity 105-a that may indicate a capability of the UE 115-a to support a divided spectrum (e.g., dividing a channel bandwidth into multiple subbands according to an antenna structure at the UE 115-a) for communications between the UE 115-a and the network entity 105-a. In such examples, the signaling 205 may indicate a quantity of antennas at the UE 115-a (e.g., antennas 302-360), a first distance between each antenna in the plurality of antennas in a first direction (e.g., distance 366), a second distance between each antenna of the plurality of antennas in a second direction (e.g., distance 368), a threshold quantity of subbands supported at the UE 115-a, a threshold (e.g., smallest) division size of the channel bandwidth (e.g., the channel bandwidth can be divided into X quantity of subbands), a threshold subband size (e.g., the smallest subband supported by the UE is X), a threshold output power of a power amplifier (PA) of the UE 115-a (where such threshold output power satisfies the MPE threshold), or a combination thereof.

In some examples, in response to receiving the signaling 205, the network entity 105-a may transmit control signaling 210 indicating a division pattern (e.g., concatenation pattern), where the division pattern indicates the division of the channel bandwidth into multiple subbands and indicates a mapping between the multiple subbands and the antennas of the UE 115-a. That is, the division pattern indicates, to the UE 115-a, which antenna to use on which subband (e.g., spectrum chunk). In such examples, the control signaling 210 may be one of a RRC signaling, downlink control information (DCI), a medium access control-control element (MAC-CE), or a combination thereof. In some examples, to support such a division pattern, a physical resource group (PRG) size associated with the communications between the UE 115-aand the network entity 105-a may be updated based on a quantity of the subbands (e.g., frequency division size) over which the UE 115-a is to transmit.

In some examples, as further described herein with reference to FIGS. 3 and 4, the network entity 105-a may determine to group one or more antennas of the UE 115-a to share a same subband (e.g., spectrum chunk), thereby creating a grating lobe. For example, the network entity 105-a may indicate that a first subset of the antennas are mapped to a first subband, a second subset of the antennas are mapped to a second subband, and a third subset of the antennas are mapped to a respective subband. Accordingly, the UE 115-a may transmit via the first subset of antennas over the first subband, thereby creating a first grating lobe, transmit via the second subset of antennas over the second subband, thereby creating a second grating lobe, and transmit via the third subset of antennas over respective subbands. The network entity 105-a may determine to group the one or more antennas onto the same subband based on one or more factors, such as quantity of UEs 115 within a coverage area, communication direction between the UE 115-a and the network entity 105-a, whether the network entity 105-a is a gNB or a satellite, or a combination thereof.

In some examples, the network entity 105-a may determine to update the division pattern. For example, the network entity 105-a may group the plurality of antennas together on the UE 115-a such that a grouping may share the spectrum chunk. In such cases, the network entity 105-a may update the division pattern based on the interference created by the grating lobes and may remove or add antennas on from the same subband

In one example, the UE 115-a may receive a second control signaling 215 that may indicates a second division pattern, where the second division pattern updates the mapping between antennas and subbands to remove one or more antennas from a same subband. For example, the network entity 105-a may determine that one or more grating lobes caused by the grouping of antennas at the UE 115-a causes interference. Accordingly, the network entity 105-a may update the division pattern to remove one or more antennas from transmitting on the same subband, thereby disbanding the grating lobe and avoiding interference. In such examples, the second control signaling 215 may be RRC signaling, a DCI, a MAC-CE, or a combination thereof.

In another example, the network entity 105-a may update the division pattern based on a lack of interference created by the grating lobes and may add antennas to transmit over a same subband. For example, the network entity 105-a may determine that interference is not caused due to the grating lobe. Accordingly, the network entity 105-a may transmit the second control signaling 215 indicating a second division pattern, where the second division pattern updates the mapping between antennas and subbands to include one or more antennas on the same subband. In such examples, the second control signaling 215 may be RRC signaling, a DCI, a MAC-CE, or a combination thereof.

In some examples, the UE 115-a may receive, via the second control signaling 215, an indication for the UE to increase an output power of the antennas across the subbands based on an EIRP of the transmission failing to satisfy a threshold. For example, the division pattern indicated in the control signaling 210 may not achieve the desired EIRP. In such cases, the network entity 105-a may indicate for the UE 115-a to increase the power of the transmission. In such examples, the second control signaling 215 may be RRC signaling, a DCI, a MAC-CE, or a combination thereof.

In some examples, the UE 115-a may receive one or more CSI-RSs 220 to perform a beam management procedure. In such examples, the UE 115-a may perform the beam management procedure using the one or more CSI-RSs 220. Additionally, the network entity 105-a may transmit the one or more CSI-RSs 220 based one of a layout of the antennas at the UE 115-a, based on the multiple subbands, based on the mapping between multiple subbands and the antennas, or a combination thereof.

FIG. 3 shows an example of an antenna structure 300 that supports divided spectrum transmissions in wireless communications in accordance with one or more aspects of the present disclosure. The antenna structure 300 may be implemented by aspects of the wireless communications system 100 and the wireless communications system 200. For example, the antenna structure 300 may be implemented by a UE 115-b, which may be examples of the corresponding devices as described with reference to FIGS. 1 and 2. The techniques described in the context of the antenna structure 300 may enable the UE 115-b to transmit at increased transmit powers, while also conforming the MPE threshold values for each antenna.

For example, the antenna structure 300 of the UE 115-b may include a quantity of antennas 302-360 (e.g., antenna elements), where each antenna may be spaced apart on the UE 115-b. That is, each antenna may be spaced apart by a distance 366 in a first direction and a distance 368 in a second direction. Due to such spacing, each antenna may be within a MPE squared area 362 or 364 (e.g., respective a 4 cm² areas), which may allow the antenna structure 300 to handle the MPE limitation on an antenna array output power and improve coverage. The techniques described may also support a divided spectrum which may help improve a grating lobe interference that may occur in the antenna structure 300. The increased threshold EIRP may also improve coverage and throughput in communications.

In some cases, the UE 115-b may transmit signaling indicating the capability to support the divided spectrum for communications between the UE 115-b and the network entity 105-a, which may be an example of the signaling 205 described in FIG. 2. The UE 115-b may receive control signaling from the network entity 105-a that may include a division pattern for the antenna structure 300. The division pattern may be based on the indicated capability of the UE 115-b.

In some cases, the division pattern may divide a channel bandwidth into multiple subbands according to the antennas at the UE 115-b. For example, if the UE 115-b transmits via the antenna 302 over a 30 MHz bandwidth at an output power of 6 dBm, which maintains the MPE threshold, the EIRP value of the antenna 302 may be 11 dBm (e.g., 6 dBm (PA)+5 dBi (patch)).

However, if the 30 MHz bandwidth is split into multiple subbands according to the quantity of antennas 302-360 (e.g., 30 antennas), the UE 115-b may transmit via each antenna over a 1 MHz bandwidth. As such, because each antenna may be spaced apart the distance 366 (e.g., 2 cm) and the distance 368 (e.g., 2 cm), the UE 115-b may utilize the full bandwidth of 30 MHz but may add output power from each antenna, resulting in an improved EIRP value of 25.5 dBm (e.g., 14.5 dB (power gain)+6 dBm (PA)+5 dBi (patch)), thereby increasing the EIRP of the UE 115-b.

In some cases, UE 115-b may also support a hybrid division pattern that may group together a multiple nearby antennas to transmit over a same subband, thereby achieving increased directivity gain, further improving the EIRP of the transmission, and improving communications between the UE 115-b and the network entity 105. As an illustrative example, the network entity 105 may indicate, via the control signaling, a division pattern that maps a same subband to the antennas 302, 304, 312, 314, 322, and 324, maps a same subband to the antennas 332, 334, 342, 344, 352, and 354, maps a same subband to the antennas 306, 308, 316, 318, 326, and 328, maps a same subband to the antennas 336, 338, 346, 348, 356, and 358, and maps a respective subband to each of the antennas 310, 320, 330, 340, 350, and 360. As such, the UE 115-b may transmit via the antennas according to the indicated division pattern, thereby improving the EIRP of the transmission.

FIG. 4 shows an example of an antenna structure 400 that supports divided spectrum transmissions in wireless communications in accordance with one or more aspects of the present disclosure. The antenna structure 300 may be implemented by a UE 115-c, which may be examples of the corresponding devices as described with reference to FIGS. 1-3.

In some cases, the UE 115-a may support the antenna structure 400 which may include sparse antenna arrays 405 (e.g., modules or panels). In such cases, antennas may be grouped together into antenna arrays 405-a, 405-b, 405-c, and 405-d. The antenna arrays 405-a, 405-b, 405-c, and 405-d may correspond to antenna panels that may be spaced apart on the UE 115-a, such that each antenna array 405 may correspond to a respective MPE squared limitation area 410-a, 410-b, 410-c, and 410-d. By implementing such an antenna structure, the UE 115-a may transmit over a respective subband via a respective antenna array 405 to achieve finer beams, while also increasing the transmit power.

In such examples, the UE 115-a may transmit signaling (e.g., signaling 205) indicating the capability to support the divided spectrum, where the UE 115-a may also indicate in the signaling the quantity of antenna arrays 405. The UE 115-a may receive control signaling (e.g., control signaling 210) from the network entity 105-a that may include a division pattern for the antenna structure 400, where the division pattern may split the channel bandwidth into four subbands and also indicate a mapping between the 4 subbands and the antenna arrays 405.

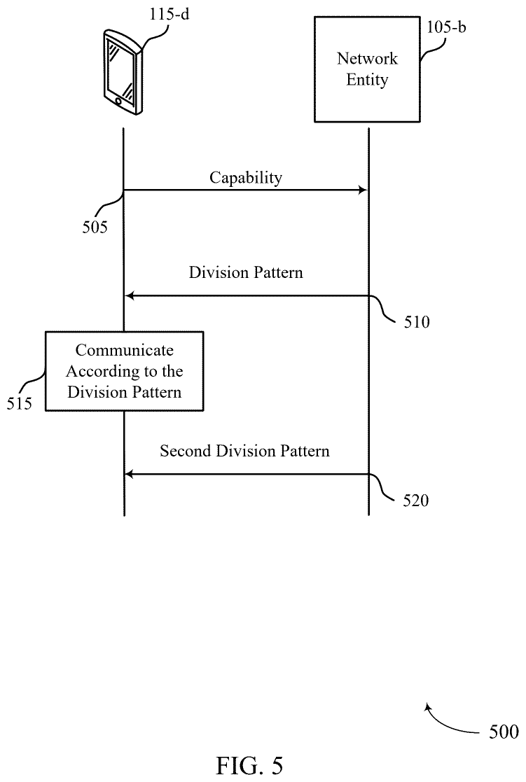

FIG. 5 shows an example of a process flow 500 that supports divided spectrum transmissions in wireless communications in accordance with one or more aspects of the present disclosure. The process flow 500 illustrates aspects of techniques performed by a UE 115-b and a network entity 105-b, which may be examples of a UE 115 and a network entity 105-b described with reference to FIGS. 1-4. Process flow 500 may support efficient signaling techniques for divided spectrum transmissions in wireless communications.

At 505, the UE 115-d may transmit signaling to the network entity 105-b indicating a capability of the UE 115-d to support a divided spectrum for communications between the UE 115-d and the network entity 105-b. As described herein, a divided spectrum may correspond to a division of a channel bandwidth into multiple subbands according to an antenna structure at the UE 115-d. In such examples, the UE 115-d may implement an antenna structure, where each antenna is spaced apart, as described herein with reference to FIG. 3, or where each antenna array is spaced apart, as described herein with reference to FIG. 4. The signaling may be an example of signaling 205 as described herein with reference to FIG. 2.

At 510, the UE 115-d may receive control signaling that may include a division pattern that is based on the capability of the UE 115-d. The control signaling may be an example of the control signaling 210 as described herein with reference to FIG. 2. At 515, the UE 115-d may communicate with the network entity 105-b according to the division pattern, as described herein with reference to FIGS. 2-4.

At 520, the UE 115-d may receive second control signaling that may include a second division pattern that updates the division pattern signaled at 510, indicates for the UE 115-d to increase transmission power, or both. For example, the second division pattern may indicate for the UE 115-d to remove or add one or more antennas from a group of antennas that are transmitting on a same subband. The second control signaling may be an example of the second control signaling 215 described herein with reference to FIG. 2.

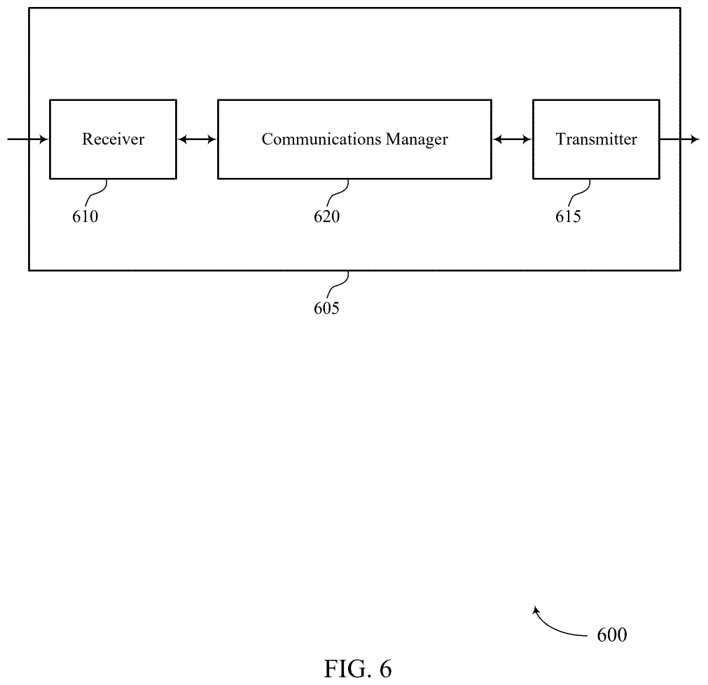

FIG. 6 shows a block diagram 600 of a device 605 that supports divided spectrum transmissions in wireless communications in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to divided spectrum transmissions in wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to divided spectrum transmissions in wireless communications). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of divided spectrum transmissions in wireless communications as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for transmitting signaling that indicates a capability of the UE to support a divided spectrum for communications between the UE and a network entity, where the divided spectrum includes division of a channel bandwidth into a set of multiple subbands in accordance with a set of multiple antennas at the UE. The communications manager 620 is capable of, configured to, or operable to support a means for receiving control signaling that includes a division pattern that is based on the capability of the UE, where the division pattern indicates the division of the channel bandwidth into the set of multiple subbands and indicates a mapping between the set of multiple antennas and the set of multiple subbands. The communications manager 620 is capable of, configured to, or operable to support a means for communicating, with the network entity, via the set of multiple antennas across the set of multiple subbands according to the division pattern.

By including or configuring the communications manager 620 in accordance with examples as described herein, the device 605 (e.g., at least one processor controlling or otherwise coupled with the receiver 610, the transmitter 615, the communications manager 620, or a combination thereof) may support signaling techniques for divided spectrum transmissions that may support reduced processing, reduced power consumption, more efficient utilization of communication resources, or any combination thereof.

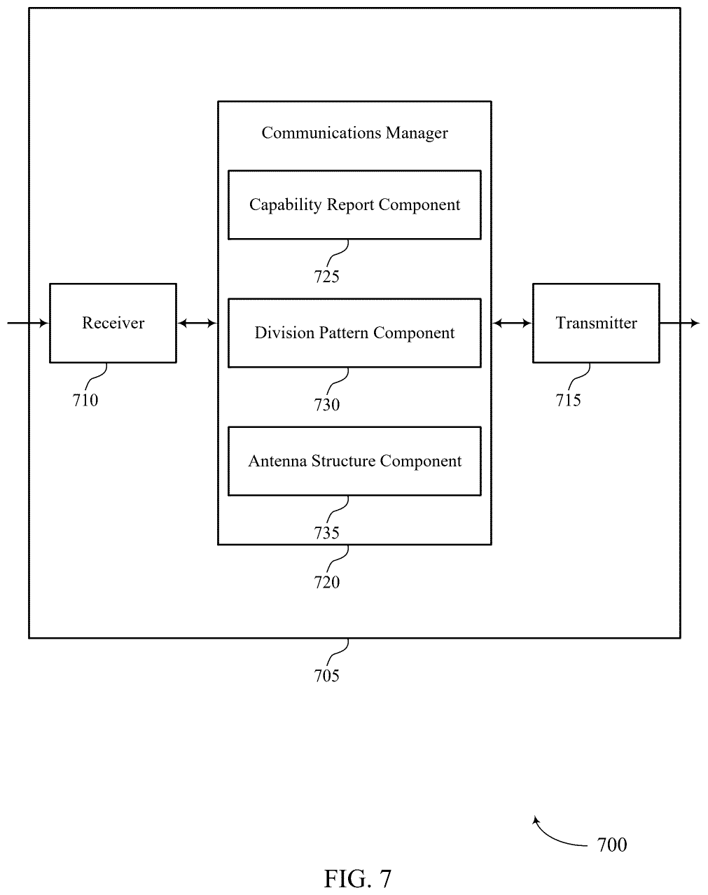

FIG. 7 shows a block diagram 700 of a device 705 that supports divided spectrum transmissions in wireless communications in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to divided spectrum transmissions in wireless communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to divided spectrum transmissions in wireless communications). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of divided spectrum transmissions in wireless communications as described herein. For example, the communications manager 720 may include a capability report component 725, a division pattern component 730, an antenna structure component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The capability report component 725 is capable of, configured to, or operable to support a means for transmitting signaling that indicates a capability of the UE to support a divided spectrum for communications between the UE and a network entity, where the divided spectrum includes division of a channel bandwidth into a set of multiple subbands in accordance with a set of multiple antennas at the UE. The division pattern component 730 is capable of, configured to, or operable to support a means for receiving control signaling that includes a division pattern that is based on the capability of the UE, where the division pattern indicates the division of the channel bandwidth into the set of multiple subbands and indicates a mapping between the set of multiple antennas and the set of multiple subbands. The antenna structure component 735 is capable of, configured to, or operable to support a means for communicating, with the network entity, via the set of multiple antennas across the set of multiple subbands according to the division pattern.

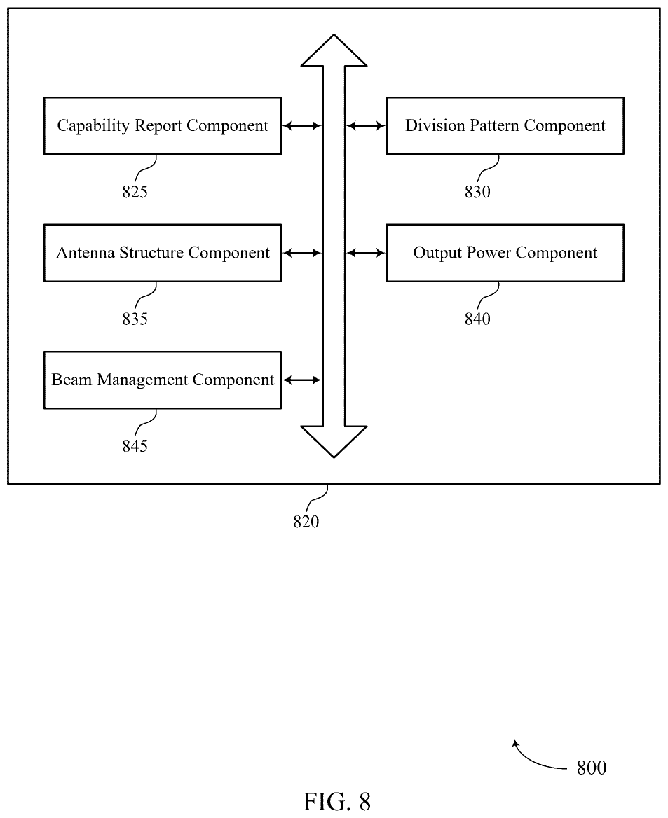

FIG. 8 shows a block diagram 800 of a communications manager 820 that supports divided spectrum transmissions in wireless communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of divided spectrum transmissions in wireless communications as described herein. For example, the communications manager 820 may include a capability report component 825, a division pattern component 830, an antenna structure component 835, an output power component 840, a beam management component 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The capability report component 825 is capable of, configured to, or operable to support a means for transmitting signaling that indicates a capability of the UE to support a divided spectrum for communications between the UE and a network entity, where the divided spectrum includes division of a channel bandwidth into a set of multiple subbands in accordance with a set of multiple antennas at the UE. The division pattern component 830 is capable of, configured to, or operable to support a means for receiving control signaling that includes a division pattern that is based on the capability of the UE, where the division pattern indicates the division of the channel bandwidth into the set of multiple subbands and indicates a mapping between the set of multiple antennas and the set of multiple subbands. The antenna structure component 835 is capable of, configured to, or operable to support a means for communicating, with the network entity, via the set of multiple antennas across the set of multiple subbands according to the division pattern.

In some examples, each antenna of the set of multiple antennas are mapped to a respective subband of the set of multiple subbands.

In some examples, a first subset of the set of multiple antennas are mapped to a first subband of the set of multiple subbands and a second subset of the set of multiple antennas are mapped to a second subband of the set of multiple subbands in accordance with the mapping.

In some examples, the division pattern component 830 is capable of, configured to, or operable to support a means for receiving second control signaling that includes a second division pattern that adds one or more antennas of the set of multiple antennas to the first subset of the set of multiple antennas, adds one or more antennas of the set of multiple antennas to the second subset of the set of multiple antennas, or both, where communicating with the network entity is based on the second control signaling.

In some examples, the division pattern component 830 is capable of, configured to, or operable to support a means for receiving second control signaling that includes a second division pattern that removes one or more antennas of the set of multiple antennas from the first subset of the set of multiple antennas, removes one or more antennas of the set of multiple antennas from the second subset of the set of multiple antennas, or both, where communicating with the network entity is based on the second control signaling.

In some examples, the output power component 840 is capable of, configured to, or operable to support a means for receiving second control signaling that indicates for the UE to increase an output power of the set of multiple antennas across the set of multiple subbands based on an EIRP of the set of multiple antennas failing to satisfy a threshold, where communicating with the network entity is based on increasing the output power of the set of multiple antennas.

In some examples, a physical resource group size associated the communications between the UE and the network entity is based on a quantity of the set of multiple subbands, and communicating with the network entity is in accordance with the physical resource group size.

In some examples, the beam management component 845 is capable of, configured to, or operable to support a means for performing a beam management procedure using one or more CSI-RSs, where the one or more CSI-RSs are based on one of a layout of the set of multiple antennas at the UE or the division pattern, where communicating with the network entity is based on performance of the beam management procedure.

In some examples, the signaling further indicates a quantity of the set of multiple antennas at the UE, a first distance between each antenna in the set of multiple antennas in a first direction, a second distance between each antenna of the set of multiple antennas in a second direction, or a combination thereof, and the division pattern is based on the quantity of the set of multiple antennas at the UE, the first distance, the second distance, or a combination thereof.

In some examples, the signaling further indicates a threshold quantity of the set of multiple subbands supported at the UE, and the division pattern is based on the threshold quantity of the set of multiple subbands.

In some examples, the signaling further indicates a threshold output power of a power amplifier of the UE, and the division pattern is based on the threshold output power of the power amplifier of the UE.

In some examples, the control signaling includes one of RRC signaling, DCI, a MAC-CE, or a combination thereof.

In some examples, the network entity includes a satellite or a gNB.

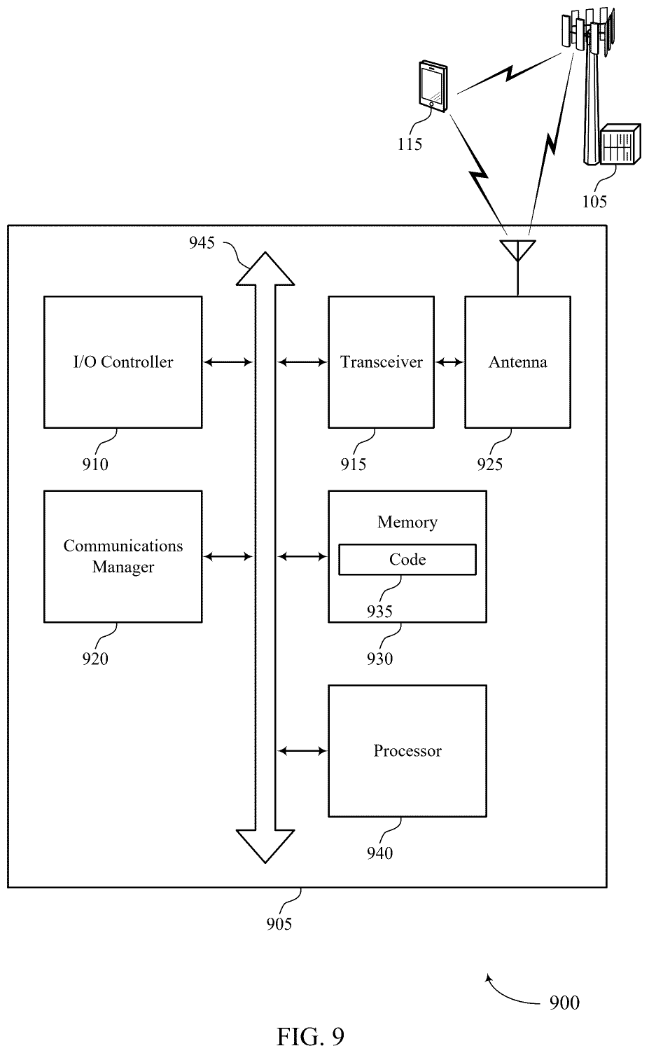

FIG. 9 shows a diagram of a system 900 including a device 905 that supports divided spectrum transmissions in wireless communications in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting divided spectrum transmissions in wireless communications). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for transmitting signaling that indicates a capability of the UE to support a divided spectrum for communications between the UE and a network entity, where the divided spectrum includes division of a channel bandwidth into a set of multiple subbands in accordance with a set of multiple antennas at the UE. The communications manager 920 is capable of, configured to, or operable to support a means for receiving control signaling that includes a division pattern that is based on the capability of the UE, where the division pattern indicates the division of the channel bandwidth into the set of multiple subbands and indicates a mapping between the set of multiple antennas and the set of multiple subbands. The communications manager 920 is capable of, configured to, or operable to support a means for communicating, with the network entity, via the set of multiple antennas across the set of multiple subbands according to the division pattern.

By including or configuring the communications manager 920 in accordance with examples as described herein, the device 905 may support signaling techniques for divided spectrum transmissions that may support improved communication reliability, reduced latency, reduced power consumption, more efficient utilization of communication resources, improved coordination between devices, improved utilization of processing capability, or any combination thereof.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of divided spectrum transmissions in wireless communications as described herein, or the at least one processor 940 and the at least one memory 930 may be otherwise configured to, individually or collectively, perform or support such operations.

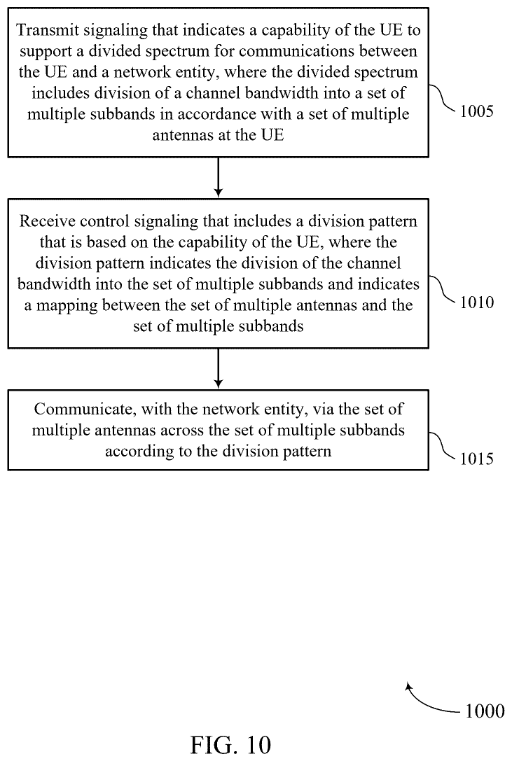

FIG. 10 shows a flowchart illustrating a method 1000 that supports divided spectrum transmissions in wireless communications in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include transmitting signaling that indicates a capability of the UE to support a divided spectrum for communications between the UE and a network entity, where the divided spectrum includes division of a channel bandwidth into a set of multiple subbands in accordance with a set of multiple antennas at the UE. The operations of 1005 may be performed in accordance with examples as disclosed herein. In some examples, aspects of the operations of 1005 may be performed by a capability report component 825 as described with reference to FIG. 8.

At 1010, the method may include receiving control signaling that includes a division pattern that is based on the capability of the UE, where the division pattern indicates the division of the channel bandwidth into the set of multiple subbands and indicates a mapping between the set of multiple antennas and the set of multiple subbands. The operations of 1010 may be performed in accordance with examples as disclosed herein. In some examples, aspects of the operations of 1010 may be performed by a division pattern component 830 as described with reference to FIG. 8.

At 1015, the method may include communicating, with the network entity, via the set of multiple antennas across the set of multiple subbands according to the division pattern. The operations of 1015 may be performed in accordance with examples as disclosed herein. In some examples, aspects of the operations of 1015 may be performed by an antenna structure component 835 as described with reference to FIG. 8.

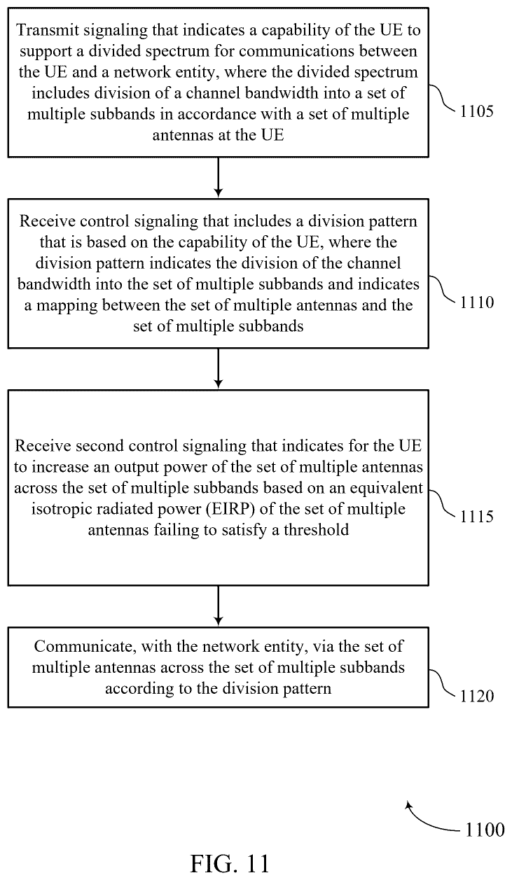

FIG. 11 shows a flowchart illustrating a method 1100 that supports divided spectrum transmissions in wireless communications in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include transmitting signaling that indicates a capability of the UE to support a divided spectrum for communications between the UE and a network entity, where the divided spectrum includes division of a channel bandwidth into a set of multiple subbands in accordance with a set of multiple antennas at the UE. The operations of 1105 may be performed in accordance with examples as disclosed herein. In some examples, aspects of the operations of 1105 may be performed by a capability report component 825 as described with reference to FIG. 8.

At 1110, the method may include receiving control signaling that includes a division pattern that is based on the capability of the UE, where the division pattern indicates the division of the channel bandwidth into the set of multiple subbands and indicates a mapping between the set of multiple antennas and the set of multiple subbands. The operations of 1110 may be performed in accordance with examples as disclosed herein. In some examples, aspects of the operations of 1110 may be performed by a division pattern component 830 as described with reference to FIG. 8.

At 1115, the method may include receiving second control signaling that indicates for the UE to increase an output power of the set of multiple antennas across the set of multiple subbands based on an EIRP of the set of multiple antennas failing to satisfy a threshold. The operations of 1115 may be performed in accordance with examples as disclosed herein. In some examples, aspects of the operations of 1115 may be performed by a division pattern component 830 as described with reference to FIG. 8.

At 1120, the method may include communicating, with the network entity, via the set of multiple antennas across the set of multiple subbands according to the division pattern and the second control signaling. The operations of 1120 may be performed in accordance with examples as disclosed herein. In some examples, aspects of the operations of 1120 may be performed by an antenna structure component 835 as described with reference to FIG. 8.

The following provides an overview of aspects of the present disclosure:
Aspect 1: A method for wireless communications at a UE, comprising: transmitting signaling that indicates a capability of the UE to support a divided spectrum for communications between the UE and a network entity, wherein the divided spectrum comprises division of a channel bandwidth into a plurality of subbands in accordance with a plurality of antennas at the UE; receiving control signaling that comprises a division pattern that is based at least in part on the capability of the UE, wherein the division pattern indicates the division of the channel bandwidth into the plurality of subbands and indicates a mapping between the plurality of antennas and the plurality of subbands; and communicating, with the network entity, via the plurality of antennas across the plurality of subbands according to the division pattern.
Aspect 2: The method of aspect 1, wherein each antenna of the plurality of antennas are mapped to a respective subband of the plurality of subbands.
Aspect 3: The method of any of aspects 1 through 2, wherein a first subset of the plurality of antennas are mapped to a first subband of the plurality of subbands and a second subset of the plurality of antennas are mapped to a second subband of the plurality of subbands in accordance with the mapping.
Aspect 4: The method of aspect 3, further comprising: receiving second control signaling that comprises a second division pattern that adds one or more antennas of the plurality of antennas to the first subset of the plurality of antennas, adds one or more antennas of the plurality of antennas to the second subset of the plurality of antennas, or both, wherein communicating with the network entity is based at least in part on the second control signaling.
Aspect 5: The method of any of aspects 3 through 4, further comprising: receiving second control signaling that comprises a second division pattern that removes one or more antennas of the plurality of antennas from the first subset of the plurality of antennas, removes one or more antennas of the plurality of antennas from the second subset of the plurality of antennas, or both, wherein communicating with the network entity is based at least in part on the second control signaling.
Aspect 6: The method of any of aspects 1 through 5, further comprising: performing a beam management procedure using one or more channel state information reference signals, wherein the one or more channel state information reference signals are based at least in part on one of a layout of the plurality of antennas at the UE or the division pattern, wherein communicating with the network entity is based at least in part on performance of the beam management procedure.
Aspect 7: A UE for wireless communications, comprising one or more memories storing processor-executable code, and one or more processors coupled with the one or more memories and individually or collectively operable to execute the code to cause the UE to perform a method of any of aspects 1 through 6.
Aspect 8: A UE for wireless communications, comprising at least one means for performing a method of any of aspects 1 through 6.
Aspect 9: A non-transitory computer-readable medium storing code for wireless communications, the code comprising instructions executable by one or more processors to perform a method of any of aspects 1 through 6.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit signaling that indicates a capability of the UE to support a divided spectrum for communications between the UE and a network entity,
wherein the divided spectrum comprises division of a channel bandwidth into a plurality of subbands in accordance with a plurality of antennas at the UE;
receive control signaling that comprises a division pattern that is based at least in part on the capability of the UE,
wherein the division pattern indicates the division of the channel bandwidth into the plurality of subbands and indicates a mapping between the plurality of antennas and the plurality of subbands; and
communicate, with the network entity, via the plurality of antennas across the plurality of subbands according to the division pattern.

2. The UE of claim 1, wherein each antenna of the plurality of antennas are mapped to a respective subband of the plurality of subbands.

3. The UE of claim 1, wherein a first subset of the plurality of antennas are mapped to a first subband of the plurality of subbands and a second subset of the plurality of antennas are mapped to a second subband of the plurality of subbands in accordance with the mapping.

4. The UE of claim 3, wherein the one or more processors are individually or collectively further operable to execute the code to cause the UE to:
receive second control signaling that comprises a second division pattern that adds one or more antennas of the plurality of antennas to the first subset of the plurality of antennas, adds one or more antennas of the plurality of antennas to the second subset of the plurality of antennas, or both, wherein communicating with the network entity is based at least in part on the second control signaling.

5. The UE of claim 3, wherein the one or more processors are individually or collectively further operable to execute the code to cause the UE to:
receive second control signaling that comprises a second division pattern that removes one or more antennas of the plurality of antennas from the first subset of the plurality of antennas, removes one or more antennas of the plurality of antennas from the second subset of the plurality of antennas, or both, wherein communicating with the network entity is based at least in part on the second control signaling.

6. The UE of claim 1, wherein the one or more processors are individually or collectively further operable to execute the code to cause the UE to:
receive second control signaling that indicates for the UE to increase an output power of the plurality of antennas across the plurality of subbands based at least in part on an equivalent isotropic radiated power (EIRP) of the plurality of antennas failing to satisfy a threshold, wherein communicating with the network entity is based at least in part on increasing the output power of the plurality of antennas.

7. The UE of claim 1, wherein a physical resource group size associated the communications between the UE and the network entity is based at least in part on a quantity of the plurality of subbands, and communicating with the network entity is in accordance with the physical resource group size.

8. The UE of claim 1, wherein the one or more processors are individually or collectively further operable to execute the code to cause the UE to:
perform a beam management procedure using one or more channel state information reference signals, wherein the one or more channel state information reference signals are based at least in part on one of a layout of the plurality of antennas at the UE or the division pattern, and wherein communicating with the network entity is based at least in part on performance of the beam management procedure.

9. The UE of claim 1, wherein the signaling further indicates a quantity of the plurality of antennas at the UE, a first distance between each antenna in the plurality of antennas in a first direction, a second distance between each antenna of the plurality of antennas in a second direction, or a combination thereof, and the division pattern is based at least in part on the quantity of the plurality of antennas at the UE, the first distance, the second distance, or a combination thereof.

10. The UE of claim 1, wherein the signaling further indicates a threshold quantity of the plurality of subbands supported at the UE, and the division pattern is based at least in part on the threshold quantity of the plurality of subbands.

11. The UE of claim 1, wherein the signaling further indicates a threshold output power of a power amplifier of the UE, and the division pattern is based at least in part on the threshold output power of the power amplifier of the UE.

12. The UE of claim 1, wherein the control signaling comprises one of radio resource control (RRC) signaling, downlink control information, a medium access control-control element (MAC-CE), or a combination thereof.

13. The UE of claim 1, wherein the network entity comprises a satellite or a gNB.

14. A method for wireless communications at a user equipment (UE), comprising:
transmitting signaling that indicates a capability of the UE to support a divided spectrum for communications between the UE and a network entity, wherein the divided spectrum comprises division of a channel bandwidth into a plurality of subbands in accordance with a plurality of antennas at the UE;
receiving control signaling that comprises a division pattern that is based at least in part on the capability of the UE, wherein the division pattern indicates the division of the channel bandwidth into the plurality of subbands and indicates a mapping between the plurality of antennas and the plurality of subbands; and
communicating, with the network entity, via the plurality of antennas across the plurality of subbands according to the division pattern.

15. The method of claim 14, wherein each antenna of the plurality of antennas are mapped to a respective subband of the plurality of subbands.

16. The method of claim 14, wherein a first subset of the plurality of antennas are mapped to a first subband of the plurality of subbands and a second subset of the plurality of antennas are mapped to a second subband of the plurality of subbands in accordance with the mapping.

17. The method of claim 16, further comprising:
receiving second control signaling that comprises a second division pattern that adds one or more antennas of the plurality of antennas to the first subset of the plurality of antennas, adds one or more antennas of the plurality of antennas to the second subset of the plurality of antennas, or both, wherein communicating with the network entity is based at least in part on the second control signaling.

18. The method of claim 16, further comprising:
receiving second control signaling that comprises a second division pattern that removes one or more antennas of the plurality of antennas from the first subset of the plurality of antennas, removes one or more antennas of the plurality of antennas from the second subset of the plurality of antennas, or both, wherein communicating with the network entity is based at least in part on the second control signaling.

19. The method of claim 14, further comprising:
performing a beam management procedure using one or more channel state information reference signals, wherein the one or more channel state information reference signals are based at least in part on one of a layout of the plurality of antennas at the UE or the division pattern, wherein communicating with the network entity is based at least in part on performance of the beam management procedure.

20. A non-transitory computer-readable medium storing code for wireless communications at a user equipment (UE), the code comprising instructions executable by one or more processors to:
transmit signaling that indicates a capability of the UE to support a divided spectrum for communications between the UE and a network entity, wherein the divided spectrum comprises division of a channel bandwidth into a plurality of subbands in accordance with a plurality of antennas at the UE;
receive control signaling that comprises a division pattern that is based at least in part on the capability of the UE, wherein the division pattern indicates the division of the channel bandwidth into the plurality of subbands and indicates a mapping between the plurality of antennas and the plurality of subbands; and
communicate, with the network entity, via the plurality of antennas across the plurality of subbands according to the division pattern.
